(19) United States
(12) Patent Application Publication
(10) Pub. No.: US 2026/0340720 A1
(43) Pub. Date: Oct. 29, 2026

(54) SYSTEMS AND METHODS FOR NON-CUSTODIAL PEER-TO-PEER LENDING

(71) Applicant: Tinkr Labs LLC, Germantown, MD (US)

(72) Inventors: Eric VITALE, Germantown, MD (US); Jeremy WILT, Germantown, MD (US); Robert MCKINNON, Germantown, MD (US); Adam JAPAK, Germantown, MD (US)

(21) Appl. No.: 19/115,403

(22) PCT Filed: Sep. 21, 2023
(86) PCT No.: PCT/US2023/074742

§ 371 Date: Mar. 26, 2025

Related U.S. Application Data
(60) Provisional application No. 63/410,452, filed on Sep. 27, 2022.

(51) Int. Cl. G06Q 40/03

(52) U.S. Cl. CPC G06Q 40/039

(57) ABSTRACT

Systems and methods of non-custodial peer-to-peer lending are disclosed. A method includes providing an online loan service. The method further includes receiving a request from a user for a collateral loan and modifying a digital ledger to include details of the loan request. The method further includes receiving at least one offer for the loan request and modifying the digital ledger to include details of the offer. The method further includes obtaining a collateral token used to secure the loan and modifying the digital ledger to include the collateral token and a smart contract specifying parties and terms of the loan. The method further includes providing a debt token to a borrower, allowing loan debt to be sold, and providing, to each lender, lender tokens that represent a percentage of the loan that each lender is owed and which allow loan shares to be sold.

### CROSS-REFERENCE AND CLAIM OF PRIORITY

This patent application claims priority to U.S. Provisional Patent Application No. 63/410,452, filed Sep. 27, 2022, the disclosure of which is hereby incorporated into this document by reference in its entirety.

### BACKGROUND

### Description of the Related Art

Today most Non-Fungible Tokens (NFTs) are associated with artwork. People own the NFTs for a variety of reasons, but for many reasons these people do not want to sell the NFTs. NFTs can hold a significant amount of value ranging from a few dollars to millions of dollars. Anyone holding an NFT as a prized possession or for other reasons has all that value locked up in the ownership of that NFT.

### SUMMARY

This disclosure generally relates to non-custodial peer-to-peer lending. In an embodiment, a method is disclosed. The method includes providing, by a computing device, an online loan service. The method further includes receiving, by the computing device, a request from a user for a collateral loan to be facilitated by the online loan service. The method further includes modifying, by the computing device, a digital ledger to include a block having details of the loan request. The method further includes receiving, by the computing device, at least one offer for the loan request and modifying, by the computing device, the digital ledger to include a block having details of the at least one offer. The method further includes performing operations, by the computing device, to start the collateral loan. The method further includes obtaining, by the computing device, a collateral token associated with collateral to be used to secure the collateral loan and modifying, by the computing device, the digital ledger to include a block having the collateral token and a smart contract specifying parties and terms of the collateral loan. The method further includes providing, by the computing device, a debt token to a borrower of the collateral loan, the debt token configured to allow loan debt to be sold, and allocating and providing, to each lender of the collateral loan, lender tokens that collectively represent a percentage of the collateral loan that the lender is owed and which are configured to allow loan shares to be sold.

Implementations of the disclosure may include one or more of the following optional features. In some embodiments, the digital ledger includes a cryptographically secure chain of blocks and modifying the digital ledger to include a block includes adding the block to the chain of blocks, the added block having a cryptographic hash of a previous block in the chain. The method may further include, before modifying the digital ledger to include a block having the details of the loan request, obtaining, by the computing device, cryptographically signed details of the loan request. Modifying the digital ledger to include a block having the details of the loan request may include modifying the digital ledger to include a borrower identifier, a loan amount, a currency type, an interest rate, and a loan duration. In some examples, modifying the digital ledger to include a block having the details of the loan request includes modifying the digital ledger to include collateral-value evidence. The smart contract may specify terms of the collateral loan including: debt payment terms, debt-token sale/purchase terms, lender-token sale/purchase terms, debt-token/collateral exchange terms, or lender-token/currency exchange terms. The collateral token may be a non-fungible token associated with a digital file. The method may further include, prior to modifying the digital ledger to include the block having details of the at least one offer, receiving, by the computing device, a selection of the at least one offer by the user. In some examples, the method further includes, prior to performing the operations to start the collateral loan, checking, by the computing device, that the selected offers meet at least one criterion of the loan request. Checking that the selected offers meet the at least one criterion of the loan request may include checking that a time period for offers has not expired.

In some examples, the details of the loan request include a loan amount and a collateral value, and the method further includes, prior to performing the operations to start the collateral loan, checking by the computing device, that the loan amount does not exceed the collateral value. In some examples, allocating and providing lender tokens includes receiving, by the computing device, a user selection of multiple offers from multiple lenders and providing, by the computing device, lender tokens to each of the multiple lenders based on the offer associated with each lender. In some examples, the method further includes receiving, by the computing device, one or more loan repayments and, in response to the one or more loan repayments satisfying a repayment term of the collateral loan, allowing exchange of the debt token for the collateral token and allowing exchange of lender tokens for currency.

In some examples, the method further includes receiving, by the computing device, debt-token purchase information and modifying, by the computing device, the digital ledger to include a block having the debt-token purchase information. In some examples, the method further includes receiving, by the computing device, lender-token purchase information and modifying, by the computing device, the digital ledger to include a block having the lender-token purchase information. Providing the online loan service may include providing a user interface to receive the request from the user for the collateral loan to be facilitated by the online loan service. Receiving the at least one offer for the loan request may include receiving a trait-based offer.

### BRIEF DESCRIPTION OF THE DRAWINGS

The present solution will be described with reference to the following drawing figures, in which like numerals represent like items throughout the figures.

FIG. 1 is an illustration of an illustrative system.

FIGS. 2A-2B (collectively referred to as “FIG. 2”) provides a flow diagram of an illustrative method for non-custodial peer-to-peer lending.

FIG. 3 illustrates a chain.

FIG. 4 provides a flow diagram of an illustrative method for processing a loan request, processing loan offers and initiating a loan.

FIG. 5 provides a flow diagram of an illustrative method for processing a loan repayment.

FIG. 6 provides a flow diagram of an illustrative method for lender claim payment.

FIG. 7 shows a message flow to facilitate a collateral loan.

FIG. 8 shows bored ape yacht club artwork associated with NFTs.

FIG. 9 shows an illustrative graphical user interface (GUI) for requesting a loan.

FIG. 10 shows an illustrative GUI for making an offer (when no other offers have been made).

FIG. 11 shows another illustrative GUI for making an offer (when other offers have been made).

FIG. 12 shows an illustrative GUI with a loan request details and multiple offer details.

FIG. 13 shows an illustrative collateral token graphic.

FIG. 14 shows an illustrative GUI for offer selection.

FIG. 15 shows an illustrative GUI for an active loan.

FIG. 16 shows an illustrative GUI for loan repayment.

FIG. 17 provides an illustration of a computing device.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment of the present solution. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Reference throughout this specification to “one embodiment”, “an embodiment”, or similar language means that a particular feature, structure, or characteristic described in connection with the indicated embodiment is included in at least one embodiment of the present solution. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

As noted above, NFTs are often associated with artwork. People own the NFTs for a variety of reasons, but for many reasons these people do not want to sell the NFTs. NFTs can hold a significant amount of value ranging from a few dollars to millions of dollars. Anyone holding an NFT as a prized possession or for other reasons has all that value locked up in the ownership of that NFT.

The present solution provides three key features to address these issues with NFTs and provide liquidity to NFT owners. These key features include: (1) allowing individuals to borrow against NFTs and using the NFTs as collateral; (2) allowing for safe storage of the collateral through a non-custodial loan program in which access to the collateral is unnecessary; and (3) allowing fractionalized loans to allow more people to be able to both lend and borrow on the online loan platform. A borrower does not have to find a single person who has enough to lend them their full amount, instead (s)he can use a combination of bids to reach his(her) borrowing goal. By increasing the number of people who are participating in the market, the online loan market is “healthier” than convention loan markets (i.e., provides a more liquid loan market with better interest rates).

The online loan platform implements a lending protocol that leverages the following techniques that are unique to the lending industry.

### #1—Fractionalized Bid Process for Providing Loans

A borrower requests to borrow an amount of digital currency and multiple (one or many) loan providers can make bids on the amount and interest rate (APR) they will charge. The borrower may select one or many of the bids which may or may not be the same amount or interest rate. The borrower receives the amount accepted as a loan and an aggregate interest rate based on the accepted bids.

### #2—Borrower Token

A borrower receives a loan provider token to represent the loan and a token associated with the loan collateral (which are both stored on a blockchain). When paying off a loan, the borrower pays back the loan plus interest and trades a debt token for the collateral. The debt token allows the borrower to sell the loan to other third parties. This is useful in cases such as when the borrower cannot satisfy the loan amount and instead of defaulting would rather sell the loan collateral at a discount. The buyer of the debt token can submit full payment to satisfy the loan and obtain the collateral using the debt token at an overall savings.

### #3—Loan Provider Tokens

When a loan provider provides a digital currency to a borrower as part of a fractionalized loan, the loan provider receives several loan provider tokens (on a blockchain) representing their share (as a percentage) of the overall loan. These loan provider tokens are easily sold to exit their stake in the loan, bought to get into a loan that has already started, or used to increase one's stake in a loan.

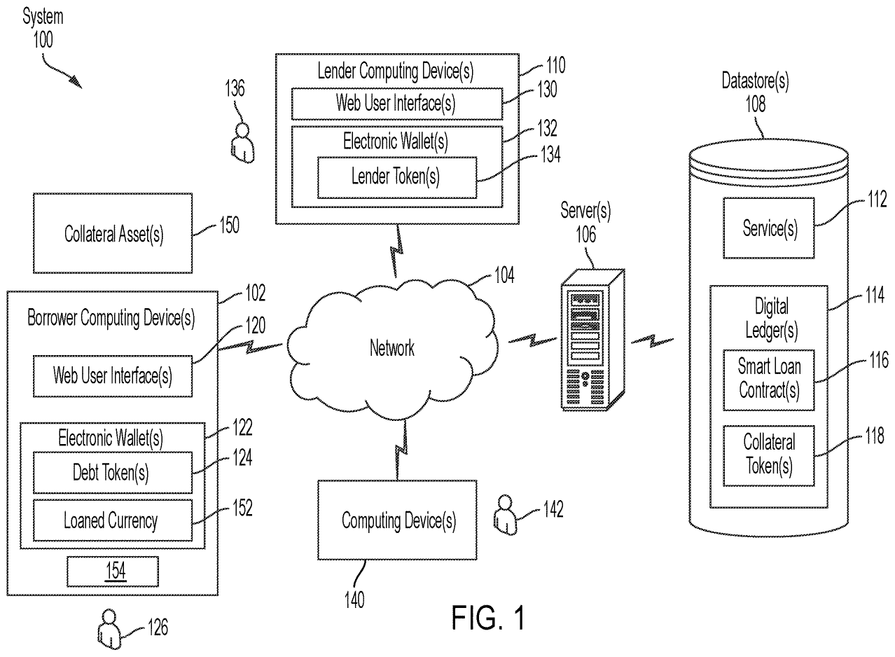

Referring now to FIG. 1, there is provided an illustration of a system 100 implementing the present solution. System 100 includes borrower computing device(s) 102, a network 104, server(s) 106, datastore(s) 108, and lender computing device(s) 110. The computing device(s) 102, 110 can include, but is(are) not limited to, personal computer(s), desktop computer(s), laptop computer(s), smart device(s), tablet(s) and/or personal digital assistant(s). The computing device(s) 102, 110 is(are) communicatively coupled to the server(s) 106 via a network 104 (e.g., the Internet or Intranet). The datastore(s) 108 can include a centralized storage system and/or a distributed storage system.

The server(s) 106 is(are) generally configured to facilitate the provision of online loan services to borrower(s) 126 and lender(s) 136. The borrower(s) 126 can include individual(s) and/or business entities (e.g., commercial business such as a restaurant, retail store or medical practice). The lender(s) can include, but are not limited to, lending entities (e.g., banks) and/or individual(s). The online loan services generally allow a borrower to request a loan using a web user interface 120 of computing device 102 and lender(s) to make offer(s) or bid(s) for the requested loan also using web user interface(s) 130 of computing device(s) 110. The borrower 126 is able to select one or more offers/bids and initiate a collateral loan with the respective lender(s) 136. The collateral loan is secured via one or more collateral assets 150. The collateral assets 150 can include, but are not limited to, physical asset(s) (e.g., real property) and/or digital asset(s) (e.g., digital artwork). The loaned currency 152 is transferred from the lender(s) to an electronic wallet 122 of the borrower 126, as part of the loan process. The loaned currency 152 can include, but is not limited to, Bitcoin (BTC) and Ethereum (ETH).

As part of the loan process, the server(s) 106 obtain or generate a number of tokens. One token that is obtained by the server(s) 106 is a collateral token 118 associated with the collateral asset(s) 150 being used by the borrower 126 to secure the loan. One or more collateral tokens can be provided for any given loan, and each collateral token can be associated with one or more collateral assets. The collateral token 118 can include, but is not limited to, an NFT. When a loan is activated, the collateral token 118 is(are) moved from the borrower's electronic wallet 122 and are locked into the smart contract 116. The collateral token 118 is stored in a digital ledger 114 along with a smart contract 116 specifying the terms of the loan. The digital ledger 114 is stored in datastore(s) 108. The digital ledger 114 may be implemented as a chain-based ledger. The chain-based ledger can include, but is not limited to, a blockchain. The term “blockchain”, as used herein, refers to a digital ledger in which transactions made between two parties are recorded chronologically, efficiently and in a verifiable and permanent way. The digital ledger defines a cryptographically secure chain of blocks. Each record in the digital ledger includes a block. Each block contains a cryptographic hash of the previous block, a timestamp, and/or transaction data. In this way, the blocks cannot be altered retroactively without the alteration of all subsequent blocks and the consensus of the network.

Another token is a debt token 124. The debt token 124 allows the borrower 126 to sell the debt to other parties 142 who access the service(s) 112 of the online loan platform via the network 104, e.g., using other computing devices 140. The debt token 124 is stored in an electronic wallet 122 of the borrower 126.

Lender tokens 134 are also generated as part of the loan process. The lender tokens 134 have the same value and are stored in the electronic wallet(s) 132 of the lender(s) 136. Each lender 136 is allocated a number of lender tokens that collectively represent the percentage of the loan that the lender is owed (i.e., loaned amount plus interest). For example, a first lender lends ten units of cryptocurrency at ten percent and a second lender lends ten units of cryptocurrency at twelve percent. The second lender will be allocated more lender tokens than the first lender. The cryptocurrency can include, but is not limited to, bitcoin and Ethereum. The present solution is not limited by the particulars of this example. The following TABLE 1 is useful for further understanding this concept.

In the scenario of TABLE 1, the loan is fractionalized into ten thousand units, the lent amount of ten Ethereum, and the loan duration is sixty days. Each lender will receive a share of these units based on the total amount of the loan repayment owed thereto. The tokens are required to claim both the amount lent but also the interest owed. A lender can sell some or all tokens to reduce its position in the loan. Anyone can buy these tokens after creation even if they were not part of the loan when it began. A lender asking for a higher interest rate but lending the same amount of currency as other lenders will receive more payment at the end of the loan.

TABLE 1

| | Amount | | Interest | Amount | % of Total | Lender Token |
|---|---|---|---|---|---|---|
| Lender | Lent | Rate | Earned | Owed | Owed | Allotment |
| 0x939A3 . . . | 20 ETH | 10.00% | 0.33 ETH | 20.33 ETH | 19.84% | 1984 |
| 0x227BC . . . | 20 ETH | 12.50% | 0.41 ETH | 20.41 ETH | 19.92% | 1992 |
| 0x11BA2 . . . | 20 ETH | 15.00% | 0.49 ETH | 20.49 ETH | 20.00% | 2000 |
| 0x3AF32 . . . | 20 ETH | 17.50% | 0.58 ETH | 20.58 ETH | 20.08% | 2008 |
| 0x7272A . . . | 20 ETH | 20.00% | 0.66 ETH | 20.66 ETH | 20.16% | 2016 |

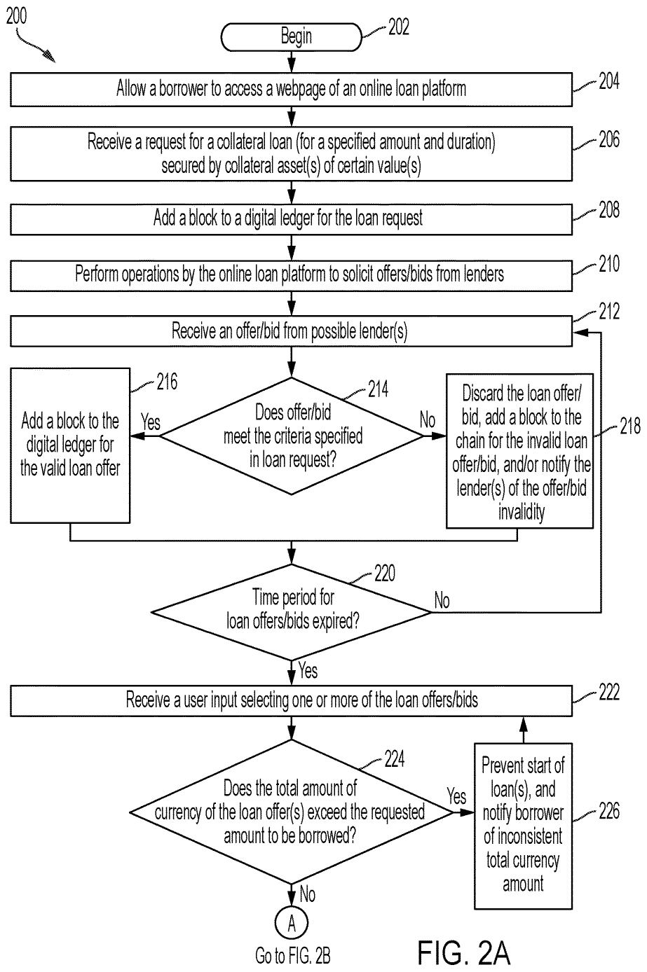

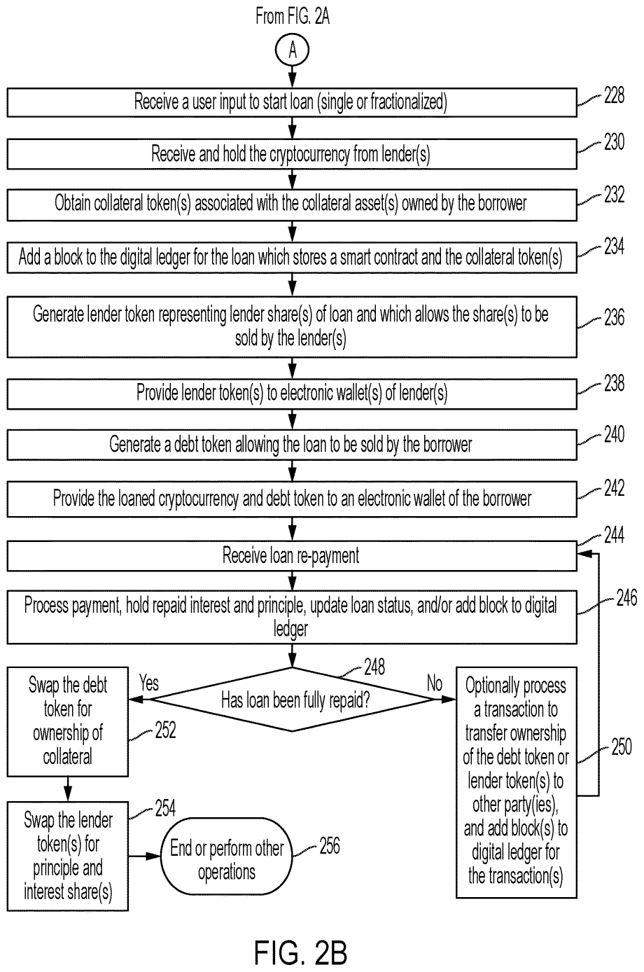

Referring now to FIG. 2, a flow diagram is provided for a method 200 implementing the present solution. Method 200 can be implemented by computing device(s) 102, 106, 110 of FIG. 1. The present solution is not limited to the order in which operations are performed in method 200. Two or more operations of method 200 can be performed in a different order than that shown in FIG. 1 and/or performed in parallel rather than in series as shown in FIG. 2.

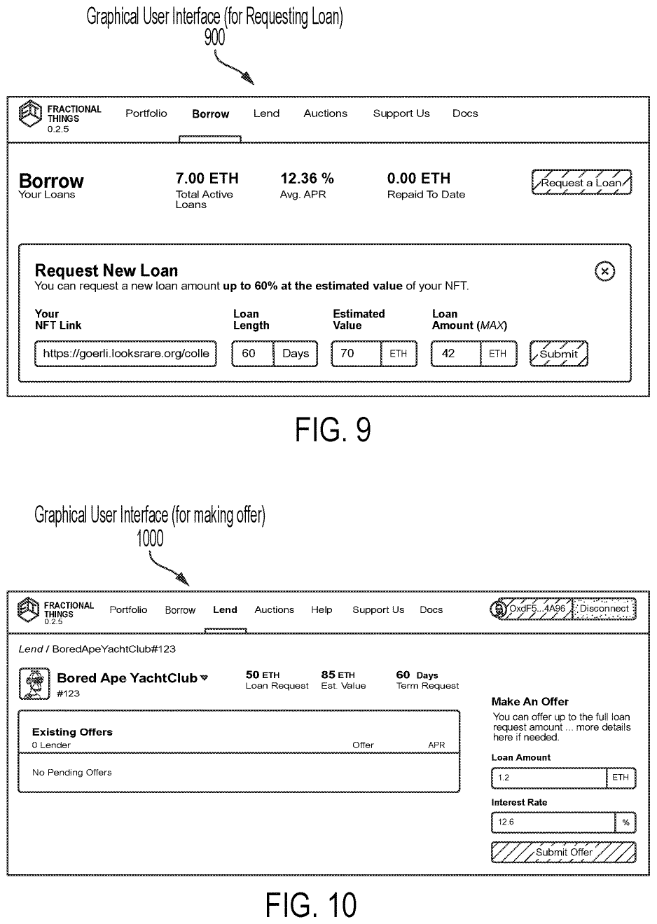

As shown in FIG. 2A, method 200 begins with 202 and continues with 204 where a server (e.g., server 106 of FIG. 1) performs operations to allow a borrower (e.g., borrower 126 of FIG. 1) to access a webpage of an online loan service (e.g., service 112 of FIG. 1) using a web user interface (e.g., web user interface 120 of FIG. 1) of a computing device (e.g., computing device 102 of FIG. 1). The borrower uses the web user interface to request a collateral loan for a specified amount and specified duration. The collateral loan is to be secured by collateral asset(s) (e.g., collateral asset(s) 150 of FIG. 1) having certain value(s). The borrower may be prompted to input evidence of the specified value(s) of the collateral asset(s). An illustrative GUI 900 for requesting a loan is shown in FIG. 9.

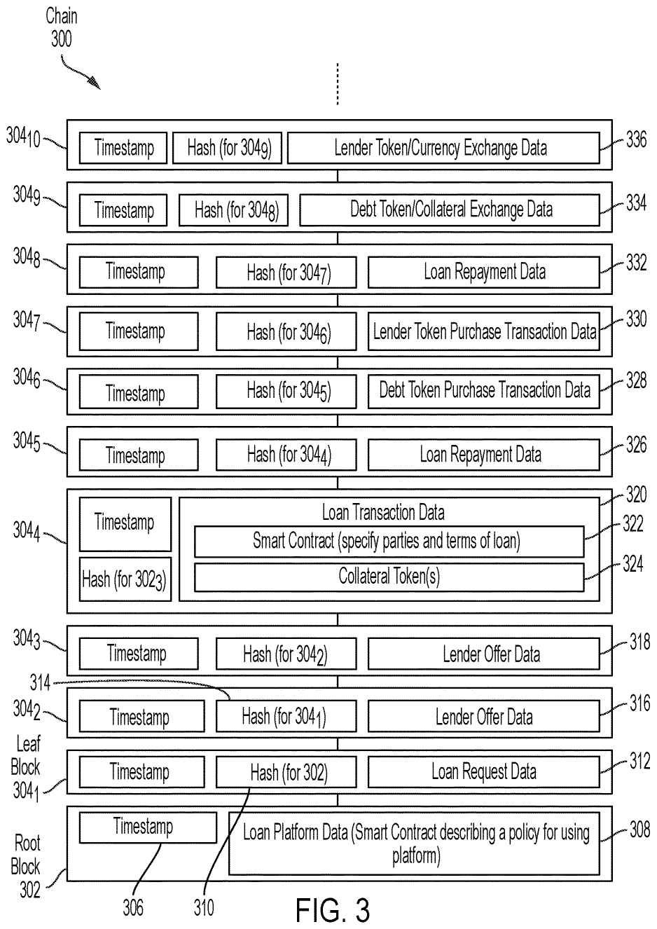

The server receives the request for the collateral loan in 206. In response to the request, the server adds a block to a digital ledger (e.g., digital ledger 114 of FIG. 1) as shown by 208. The block includes a timestamp, a hash value of a previous block in the digital ledger, and the details of the loan request (e.g., borrower identifier, loan amount, currency type, interest rate, and loan duration). An illustrative block 304₁ of this type is shown in FIG. 3.

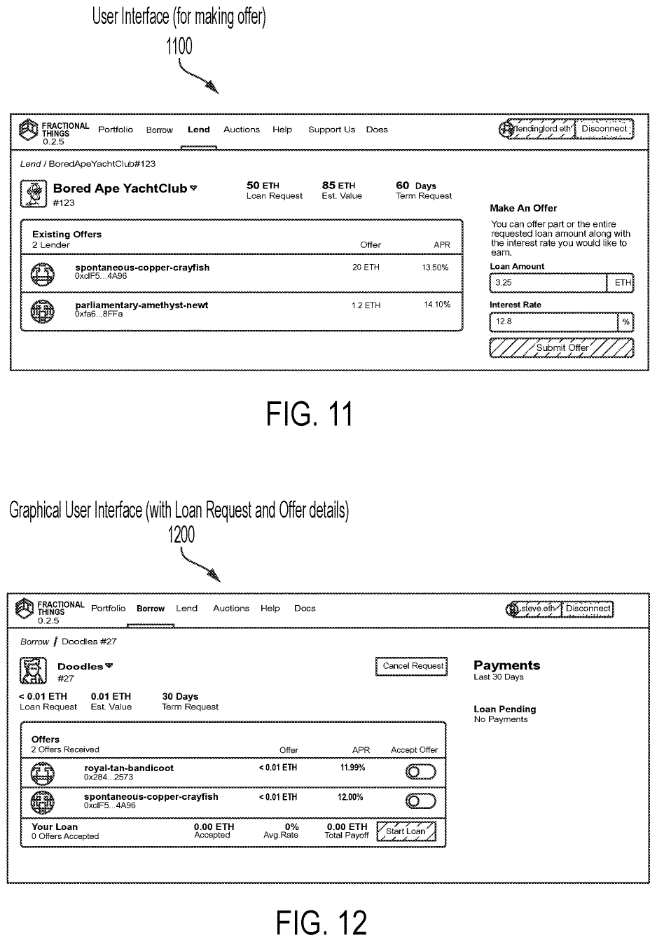

In 210, the server performs operations to solicit offers/bids from lender(s) (e.g., lender(s) 136 of FIG. 1). The time period in which lender(s) can make offer(s)/bid(s) can be limited by the system. For example, the offer/biding window can be set to N hours, days and/or weeks. N can be any number greater than zero. The server receives an offer/bid in 212. The offer/bid can be made by lenders for the full or partial loan amount. Illustrative GUIs 1000, 1100, and 1200 for making offers are shown in FIGS. 10-12.

In 214, the server checks whether the offer/bid meets the criteria specified by the borrower in the loan request for the collateral loan. The criteria can include, but is not limited to, total amount to be borrowed, type of currency, loan duration, a loan type, and/or interest rate.

When the server concludes that the offer/bid does meet the loan criteria [214:YES], method 200 continues to 216. In 216, the server performs operations to add a block to the digital ledger for valid loan offer. The block can include lender identifier(s), a time stamp associated with the loan offer/bid, and/or loan offer/bid details (e.g., loan amount and interest rate). Illustrative blocks 304₂, 304₃ of this type are shown in FIG. 3. Method 200 then continues with 220 which will be discussed below.

When the server concludes that the offer/bid does not meet the loan criteria [214:NO], method 200 continues to 218. In 218, the server may perform operations to (i) discard the loan offer, (ii) add a block to the digital ledger for the invalid loan offer, and/or (iii) notify the lender(s) that the loan offer/bid does not meet the loan criteria and is therefore considered an invalid loan offer/bid. Method 200 then continues with 220.

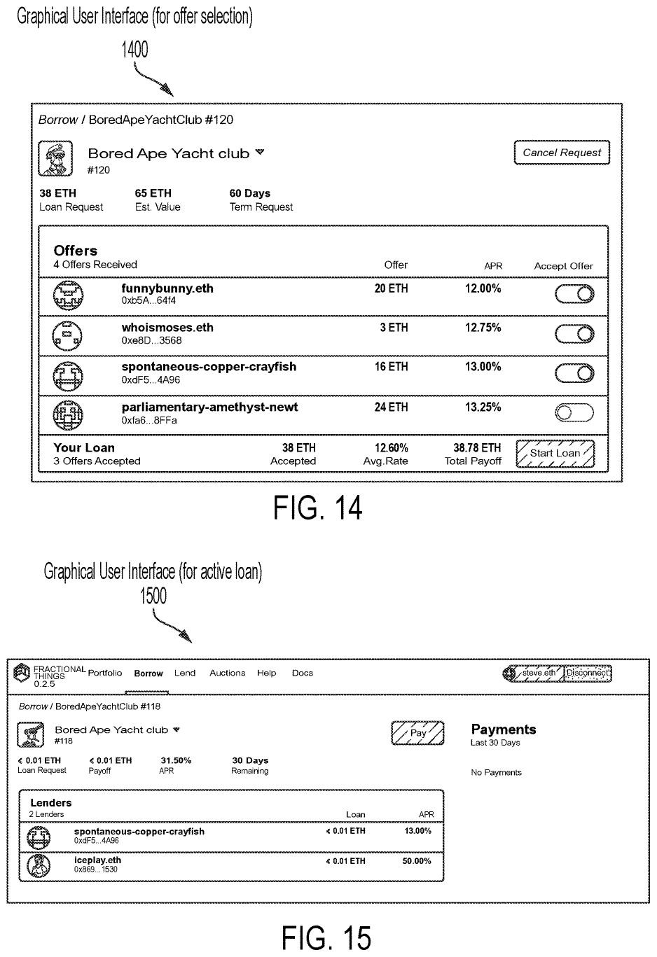

In 220, the server checks whether the time period for making loans/bids has expired. If not [220:NO], method 200 returns to 212. If so [220:YES], method 220 continues to 222 where the server receives a user input selecting one or more of the loan offers/bids. A borrower may accept any number of loans that individually or collectively meet the loan criteria. In this way, the online loan platform allows for fractionalized loans. An illustrative GUI 1400 for offer selection is shown in FIG. 14.

When the server receives a user selection of offer(s)/bid(s), the server performs another check to determine whether the total amount of currency to be borrowed exceeds the amount specified in the loan request. If so [224:YES], then method 200 continues with 226. In 226, the server may perform operations to prevent the start of the loan(s) and/or notifies the borrower of the inconsistency between the requested loan amount and the total loan amount. For example, a borrower requests a loan for fifty Ethereum secured by a collateral asset worth one hundred Ethereum. The system prevents the borrower from taking out a loan (fractionalized) for more than fifty Ethereum to ensure that the loan risk for the lenders does not change. If the borrower takes out a loan for seventy-five Ethereum (rather than fifty Ethereum) then the loan risk increases. However, if the borrow takes out a loan for twenty Ethereum (rather than fifty Ethereum), then the loan risk decreases. The present solution is not limited to the particulars of this example.

When the server concludes that the total amount of currency to be borrowed does not exceed the amount specified in the loan request [224:NO], method 200 continues with 228 of FIG. 2B. As shown in FIG. 2B, block 228 involves receiving a user input to start a loan (fractionalized). The user input can be facilitated by a web page of the online loan service and the web user interface displayed on the borrower's computing device.

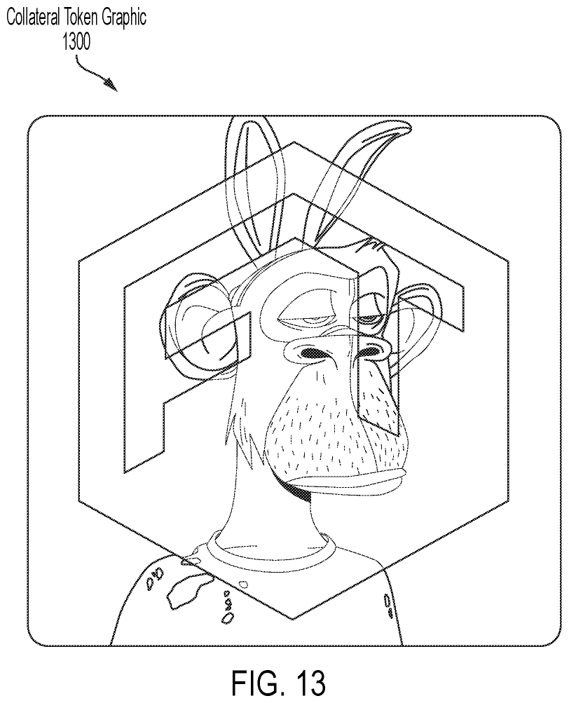

The server then performs operations 230-242 to start the loan. Operations 230-234 involve: receiving and holding the cryptocurrency from the lender(s); obtaining collateral token(s) (e.g., collateral token(s) 118 of FIG. 1) associated with the collateral asset(s) owned by the borrower; and adding a block to the digital ledger for the loan which stores a smart contract (e.g., smart contract 116 of FIG. 1) and the collateral token(s). The smart contract specifies the parties to the loan as well as the terms of the loan. These terms may include debt payment, debt token sale/purchase, lender-token sale/purchase, debt-token/collateral exchange, lender-token/currency exchange, and so forth. An illustrative collateral token graphic 1300 is shown in FIG. 13.

In 236, the server generates lender tokens (e.g., lender tokens 134 of FIG. 1). The lender tokens represent lender share(s) of the loan and allow the share(s) to be sold by the lender(s). As noted above, the lender tokens have the same value. Each lender 136 is allocated a number of lender tokens that collectively represent the percentage of the loan that the lender is owed (i.e., loaned amount plus interest). The lender tokens are allocated to the lender(s) and stored in their electronic wallet(s) (e.g., electronic wallet(s) 132 of FIG. 1), as shown by 238.

In 240, the server generates a debt token (e.g., debt token 124 of FIG. 1). The debt token allows the borrower to sell the debt to other parties (e.g., individual(s) 142 of FIG. 1) via the online loan service(s). The loaned cryptocurrency and debt token are allocated to the borrower and stored in his(her) electronic wallet (e.g., electronic wallet 122 of FIG. 1), as shown by 242.

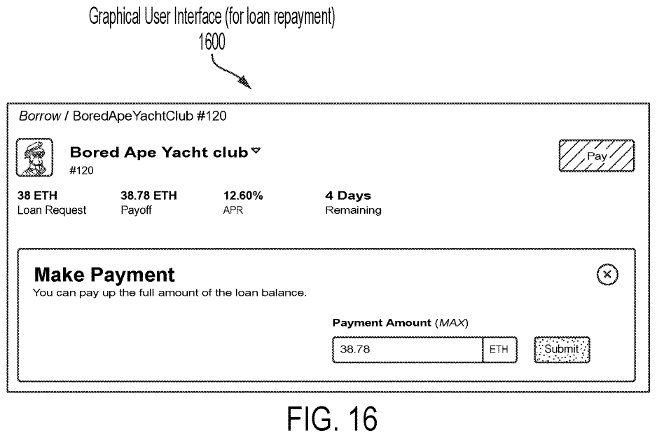

The system then waits for loan repayment. The loan repayment can be made by the borrower or any other individual using a GUI of the online loan platform. An illustrative GUI 1500 for an active loan is shown in FIG. 15, and an illustrative GUI 1600 for loan repayment is shown in FIG. 16. A loan repayment is received by the system in 244. The server processes the payment, causes the system to hold the repaid principle and/or interest in an electronic wallet of the online loan platform, and updates the loan status. A block is added to the digital ledger for the loan repayment. The block can include a timestamp, a hash value of a previous block, and payment details (e.g., loan identifier, borrower identifier, total paid amount, currency, amount of paid amount applied to interest, and/or amount of paid amount applied to principle).

In 248, the server performs operations to check whether the loan has been fully repaid. If not [248:NO], then method 200 continues with 250 where the server optionally processes a transaction to transfer ownership of the debt token or lender token(s) to other parties (e.g., individual(s) 142 of FIG. 1), and/or add block(s) to the digital ledger for the transaction(s). Method 200 then returns to 244 so that other loan repayments can be made.

When the loan is fully repaid [248:YES], operations of blocks 252-254 are performed. These operations involve: swapping the debt token for ownership of the collateral; and swapping the lender tokens for the principle and/or interest share(s). Anyone who owns or otherwise has possession of the debt token can redeem the same for the collateral. Subsequently, 256 is performed where method 200 ends or other operations are performed (e.g., return to 204 of FIG. 2A).

Referring now to FIG. 3, there is provided an illustration of a chain 300 which is created during performance of an online loan process (e.g., method 200 of FIG. 2). The chain 300 provides a digital ledger in which loan related transactions are recorded chronologically, efficiently and in a verifiable and permanent way. Chain 300 may be stored in datastore(s) (e.g., datastore 108 of FIG. 1) as a digital ledger (e.g., digital ledger 114 of FIG. 1). The chain 300 includes a cryptographically secure chain of blocks. The blocks include a root block 302 and a multiple leaf blocks 304₁, . . . , 304_{X} (collectively referred to as “304”). X is any number greater than zero. Chain 300 can include less or more blocks than that shown in FIG. 3.

Starting from the bottom of FIG. 3, the root block 302 includes a timestamp 306 and loan platform data 308. The loan platform data 308 can include, but is not limited to, a smart contract describing a policy for using the online loan platform.

Leaf block 304₁ provides a record of a loan request made by an individual of the online loan platform. The leaf block 304₁ includes a timestamp, a hash 310 for the previous block (e.g., root block 302), and loan request data 312. The timestamp may include a time of the block's creation and/or a time at which a loan request was made or received by the system. Hash values are well known in the art. Algorithms for generating hash values are also well known in the art. Any known or to be known hash algorithm can be used herein without limitation to generate hashes of blocks in the chain 300. The loan request data 312 may include, but is not limited to, a borrower identifier, a loan amount, a currency type (e.g., bitcoin or Ethereum), an interest rate, a loan duration, a loan type, collateral identifier(s), collateral value(s), and/or collateral value evidence (certificate(s) of authenticity and/or appraisal documentation).

Leaf block 304₂ provides a record of an offer or bid for the loan request made by lender(s). The leaf block 304₂ includes a timestamp, a hash 314 for the previous block (e.g., leaf block 304₁), and lender offer data 316. The timestamp may include a time of the block's creation and/or a time at which the loan offer/bid was made or received by the system. The lender offer data 316 may include, but is not limited to, a lender identifier, a loan amount, a loan type, a currency type, and/or an interest rate.

Leaf block 304₃ provides a record of another offer or bid for the loan request made by multiple lenders. This type of offer or bid is also referred to herein as a fractionalized offer or bid. The leaf block 304₃ includes a timestamp, a hash for the previous block (e.g., leaf block 304₂), and lender offer data 318. The timestamp may include a time of the block's creation and/or a time at which the fractionalized loan offer/bid was made or received by the system. The lender offer data 318 may include, but is not limited to, lender identifiers, loan amounts, loan types, currency types, and/or interest rates.

Leaf block 304₄ provides a record of a loan made between the borrower and lender(s). The leaf block 304₄ includes a timestamp, a hash for the previous block (e.g., leaf block 304₃), and loan transaction data 320. The timestamp may include a time of the block's creation. The loan transaction data 320 may include, but is not limited to, a smart contract 322 and collateral token(s) 324. The smart contract 322 specifies the parties and terms of the loan. The collateral token(s) 324 is(are) associated with the collateral asset(s) that are being used by the borrower to secure the loan.

Leaf block 304s provides a record of loan repayment. The leaf block 304₅ includes a timestamp, a hash for the previous block (e.g., leaf block 304₄), and loan repayment data 326. The timestamp may include a time of the block's creation and/or a time at which the loan repayment was made. The loan repayment data 326 may include, but is not limited to, payer identifier, repayment amount, collateral type, payment date, amount of payment applied to principle, amount of payment applied to interest, and/or loan status after payment.

Leaf block 304₆ provides a record of debt token purchase transaction. The leaf block 304₆ includes a timestamp, a hash for the previous block (e.g., leaf block 304₅), and debt token purchase transaction data 328. The timestamp may include a time of the block's creation and/or a time at which the purchase transaction occurred. The debt token purchase transaction data 328 may include, but is not limited to, seller identifier (e.g., borrower of loan), buyer identifier, debt token identifier, purchase amount, currency type, transaction date, identifier of seller's electronic wallet from which the debt token was transferred, and/or identifier of buyer's electronic wallet to which the debt token was transferred.

Leaf block 304₇ provides a record of lender token purchase transaction. The leaf block 304₇ includes a timestamp, a hash for the previous block (e.g., leaf block 304₆), and lender token purchase transaction data 330. The timestamp may include a time of the block's creation and/or a time at which the purchase transaction occurred. The data 330 may include, but is not limited to, a seller identifier (e.g., the lender), a buyer identifier, a purchase amount, currency type, transaction date, lender token identifier(s), an identifier of seller's electronic wallet from which the debt token was transferred, and/or an identifier of buyer's electronic wallet to which the debt token was transferred.

Leaf block 304₈ provides a record of loan repayment. The leaf block 304₈ includes a timestamp, a hash for the previous block (e.g., leaf block 304₇), and loan repayment data 332. The timestamp may include a time of the block's creation and/or a time at which the loan repayment was made. The loan repayment data 332 may include, but is not limited to, payer identifier, repayment amount, collateral type, payment date, amount of payment applied to principle, amount of payment applied to interest, and/or loan status after payment.

Leaf block 304₉ provides a record of a debt token exchange for collateral. The leaf block 304₉ includes a timestamp, a hash for the previous block (e.g., leaf block 304₇), and exchange data 334. The timestamp may include a time of the block's creation and/or a time at which the exchange transaction occurred. The data 334 may include, but is not limited to, a debt token identifier, a collateral token identifier, an identifier of an original owner of the collateral token, and/or an identifier of a new owner of the collateral token.

Leaf block 304₁₀ provides a record of a lender token exchange for collateral. The leaf block 304₁₀ includes a timestamp, a hash for the previous block (e.g., leaf block 304₉), and exchange data 336. The timestamp may include a time of the block's creation and/or a time at which the exchange transaction occurred. The data 336 may include, but is not limited to, lender token identifiers, identifier(s) of person exchanging lender tokens, amount of principle provided in exchange for the lender tokens, and/or an amount of interest provided in exchange for the lender tokens.

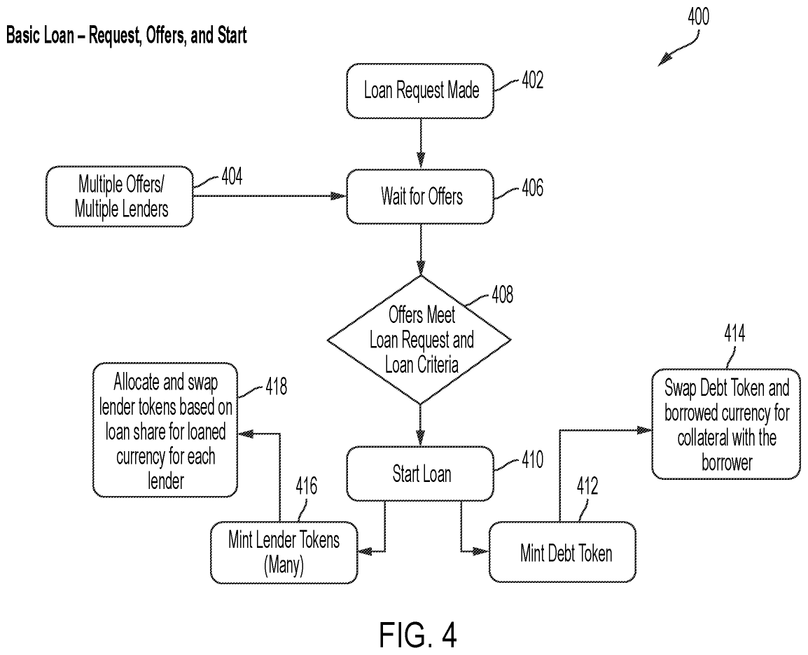

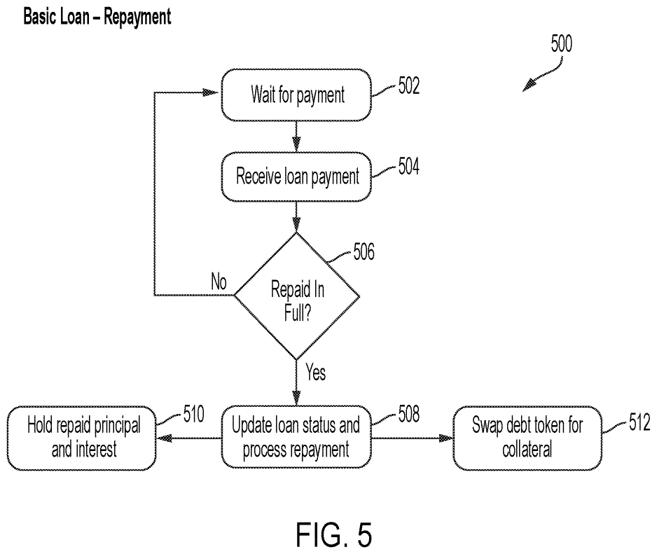

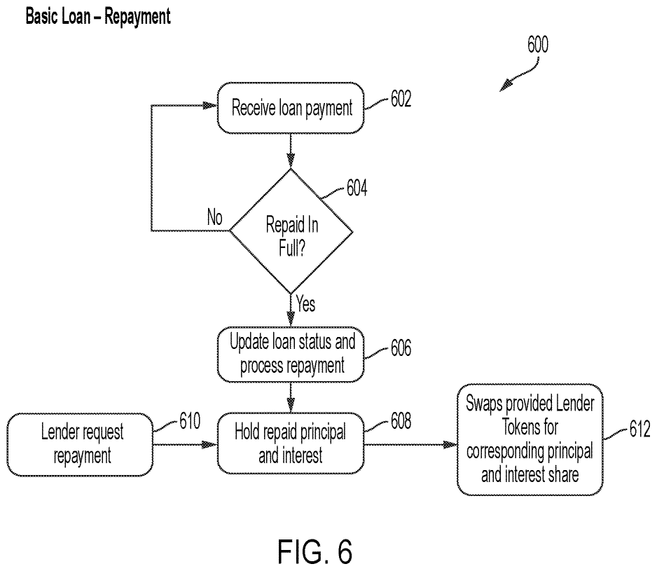

Additional flow diagrams are provided in FIGS. 4-6 that are useful for further understanding the present solution. FIG. 4 shows a basic loan process 400. FIG. 5 shows a basic loan repayment process 500. FIG. 6 shows a lender claim payment process 600.

The basic loan process 400 generally involves: making a loan request in block 402; waiting for offers in block 406; receiving offers in block 404; analyzing the offers to determine whether they meet loan request and loan criteria in block 408; starting the loan in block 410; minting a debt token in block 412; swapping the debt token and borrowed currency for collateral in block 414; minting lender tokens in 416; allocating and swapping lender tokens based on loan share for loaned currency for each lender in block 418.

The basic loan repayment process 500 generally involves: waiting for payment in block 502; receiving a loan payment in block 504; determining whether the loan has been fully paid with this repayment in decision block 506; returning to block 502 when the loan has not yet been fully repaid; continuing to block 508 when the loan has been fully paid; updating the loan status and process repayment in block 508; hold repaid principle and interest in block 510; and swap debt token for collateral in 512.

The lender claim payment process 600 generally involves: receiving a loan repayment in block 602; determining whether the loan has been fully paid with this repayment in decision block 604; returning to block 602 when the loan has not yet been fully repaid; continuing to block 606 when the loan has been fully paid; updating the loan status and process repayment in block 606; hold repaid principle and interest in block 608; receiving a request for repayment from a lender in block 610; and swap lender tokens for corresponding principle and interest share in block 612.

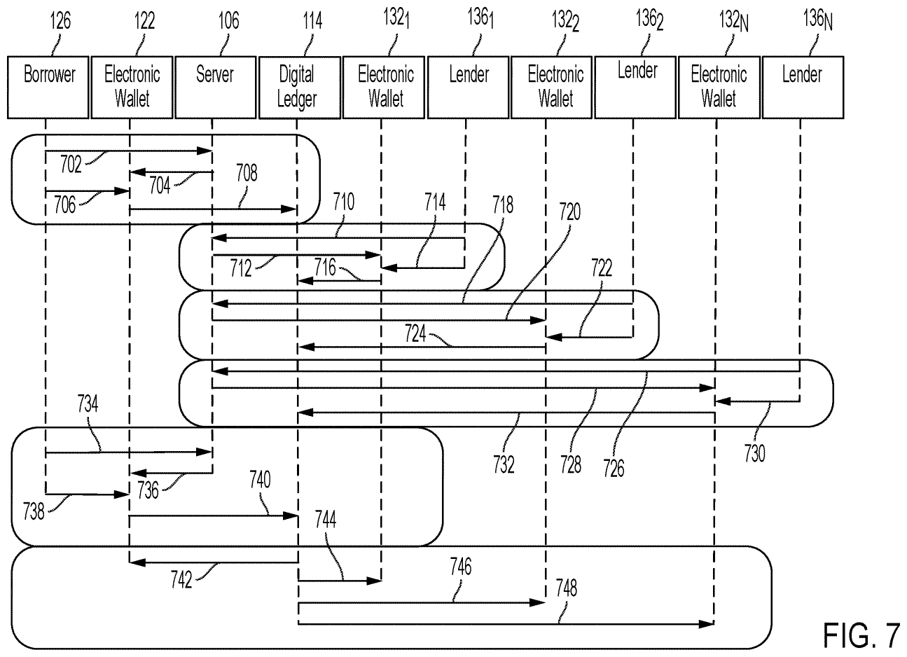

FIG. 7 shows a message flow associated with the basic loan process. This process begins when a borrower (e.g., individual 126 of FIG. 1) performs user-software interaction facilitated by software (e.g., software application 154 of FIG. 1 and/or web user interface 120 of FIG. 1) of his(her) computing device (e.g., computing device 102 of FIG. 1) which is accessing an online loan service. The online service is provided by a server (e.g., server 106 of FIG. 1). The user-software interaction is performed to enter a loan request as shown by arrow 702. The loan request specifies at least collateral, an estimated value for the collateral, a loan amount, and a loan duration. The sever generates a message with the loan request and requests a wallet signature for the transaction from an electronic wallet (e.g., electronic wallet 122 of FIG. 1) as shown by arrow 704. The borrower is prompted to authorize the wallet signature. This authorization is provided via a user-software interaction facilitated by the electronic wallet as shown by arrow 706. The transaction is signed and published to a digital ledger (e.g., digital ledger 114 of FIG. 1) as shown by 708.

At a later time, the server receives a bid on the loan request from a first lender 136₁ as shown by arrow 710. The bid is entered via a user-software interaction facilitated by a web user interface (e.g., web user interface 130 of FIG. 1) presented by a computing device (e.g., computing device 110 of FIG. 1). The server generates a message with the bid and requests a wallet signature for the transaction from an electronic wallet 132₁, as shown by arrow 712. The first lender is prompted to authorize the wallet signature. This authorization is provided via a user-software interaction facilitated by the electronic wallet as shown by arrow 714. The transaction is signed by the electronic wallet and published to the digital ledger as shown by 716.

The server may also receive and process another bid on the loan request from other lenders 136₂, . . . , 136_{N} as shown by arrows 718-724, 726-732.

Once the bidding period has expired, the borrower is prompted to select one or more bids and request that the loan be started. This selection is made via a user-software interaction facilitated by the web user interface presented by the borrower's computing device. A message is sent from the borrower's computing device to the server as shown by arrow 734. The message includes information identifying the selected bid(s) and includes the request for starting the loan. The sever packages the loan transaction and requests a wallet signature from the borrower's electronic wallet. The borrower is prompted to authorize the wallet signature. This authorization is provided via a user-software interaction facilitated by the electronic wallet as shown by arrow 738. The transaction is signed and published to the digital ledger as shown by 740.

Operations are then performed to: transfer a debt token to the borrower as shown by arrow 742; and transfer lender token to the lenders as shown by arrows 744, 746, 748 (based on the overall percentage of repayment owed).

The present solution also concerns online services to allow the lender to offer a loan to someone who has not asked for a loan (yet) based on the collateral (s)he own. These types of lender offers are referred to herein as a “collection offer” and a “trait-based offer.” In both cases, these offers create efficiency for a lender. For example, these offers can save the lenders time. The lenders can make offers on multiple collateral tokens in about the same time they can make an offer on a single collateral token. Additionally, a lender can save significantly in the amount of network fees they will have to pay to make a single collection offer versus making many single offers across a collection of assets. In the case of trait-based offer, the lender is allowed to offer to lend more cryptocurrency because the particular combination of traits they have selected are far more valuable than tokens in the collection that do not have these traits. For example, all bored apes are worth 70 ETH minimum (as of right now), but a bored ape with pizza in his mouth has a minimum asking price of 159 ETH. The present solution is not limited to the particulars of this example.

### Collection Offer

The purpose of a collection offer is to allow a lender to specify a loan offer that will apply to a whole collection of NFTs, not just a single NFT. There are two types of collection offers. Fixed and floating.

Let's say there are eighty requests to borrow against Bored Ape Yacht Club collateral. So, a loan provider can bid individually on all eighty individual requests. Instead of making eighty bids on the requests one-by-one, the lender can just make a collection offer for all eighty requests. A collection offer is an offer against any NFTs in a particular collection. A “particular collection” is defined as a set of NFTs that were all generated by the same smart contract.

A lender can make an offer that offers thirty Ethereum which can be accepted by any loan request that is using Bored Ape Yacht Club as collateral. This amount can be partially accepted, meaning if only ten of the thirty Ethereum offer is accepted, twenty Ethereum remain and can be accepted by one or more other loans until the amount is depleted.

Fixed and floating collection offers can be made using the present solution. A fixed collection offer requires the lender to specify a total loan amount which is the total amount of cryptocurrency (s)he wants to make available on this collection to borrow. This matters as the lender might have more cryptocurrency in his(her) account than (s)he wants to lend out. For example, the lender could have one hundred Ethereum in their account, but only want to lend a maximum of thirty Ethereum to the Bored Ape Yacht Club. So total amount lent is “fixed” or “capped” at thirty Ethereum. The present solution is not limited to the particulars of this example.

A floating collection offer does not require a total loan amount as the amount is considered floating based on the total amount of cryptocurrency in the lender's account at any given time. If the lender creates a floating loan offer, (s)he make the total amount of cryptocurrency in their account available to be borrowed. If the account balance goes up, more is available to borrow. If the account balance goes down, less is available to borrow.

### Trait-Based Offer

The purpose of a trait-based offer is to allow a lender to specify a loan offer that will apply to a subset of NFTs in a collection, not just a single NFT and not the whole collection. Other than the specified traits restricting what the loan offers are for, a trait-based offer works just like a collection offer.

### Example 1 (Single Trait)

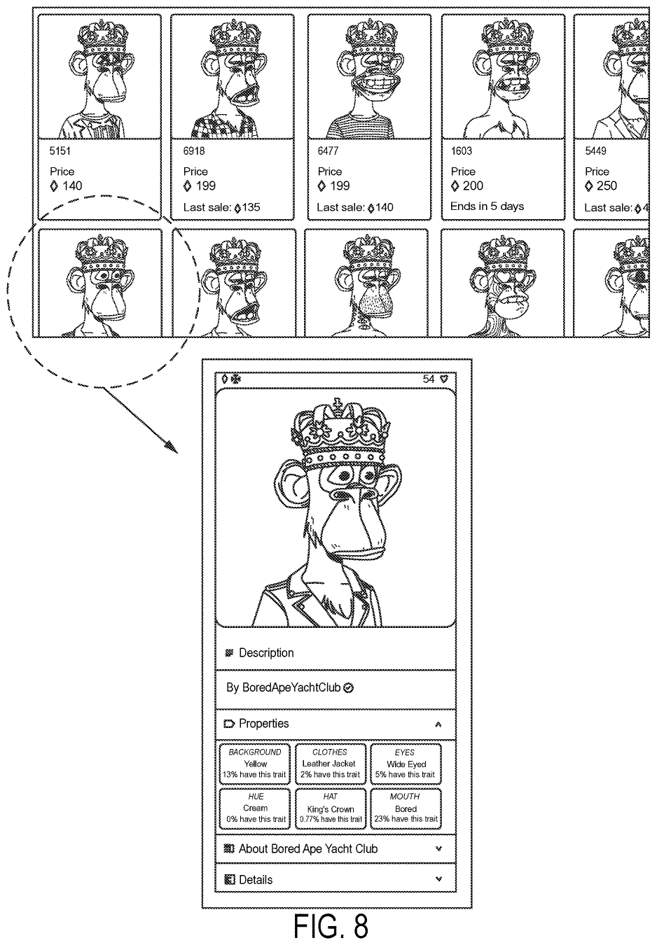

In a Bored Ape Yacht Club collection, there are seventy-seven NFTs that are associated with a graphic of an ape with a king's crown. A few of these images are shown in FIG. 8. These graphics are technically specified in the NFT metadata as ‘hat’=‘King's Crown’. (See the “Properties” section in the bottom image of FIG. 8.). A trait-based offer for just bored apes that have a king's crown would only apply to the seventy-seven NFTs associated with images having this attribute.

### Example 2 (Multiple Traits)

A multi-trait offer works just like a single-trait offer, just restricts based on more than one trait. In this case, the lender is making a loan offer to any NFT in the Bored Ape collection that has: “Hat”=“King's crown” AND (“Mouth”=“Bored pizza” OR “Mouth”=“Bored unshaven pizza”).

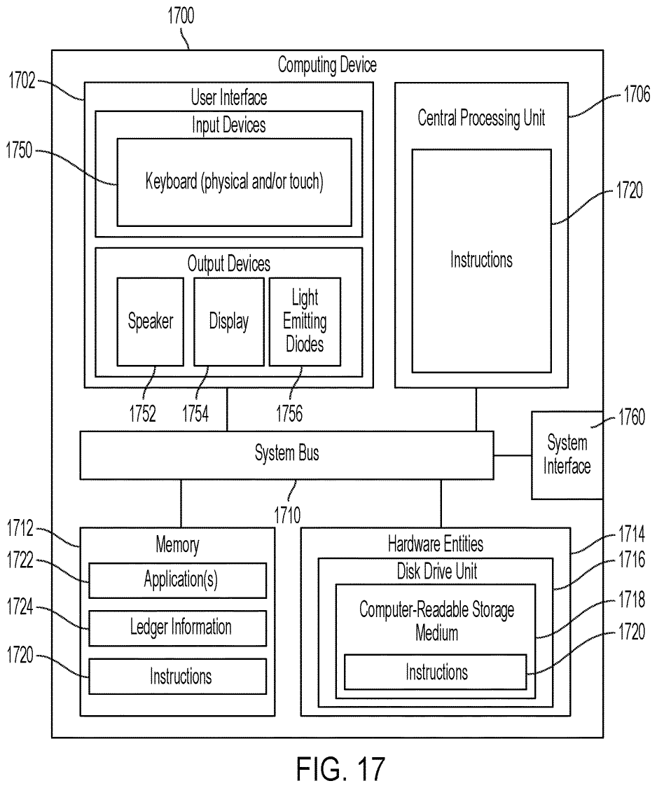

Referring now to FIG. 17, there is provided an illustration of an architecture for a computing device 1700. Computing device(s) 102, 106, 110, 140 of FIG. 1 is(are) the same as or similar to computing device 1700. As such, the discussion of computing device 1700 is sufficient for understanding these components of system 100.

In some scenarios, the present solution is used in a client-server architecture. Accordingly, the computing device architecture shown in FIG. 17 is sufficient for understanding the particulars of client computing devices and servers.

Computing device 1700 may include more or less components than those shown in FIG. 17. However, the components shown are sufficient to disclose an illustrative solution implementing the present solution. The hardware architecture of FIG. 17 represents one implementation of a representative computing device configured to provide an online loan platform and/or services, as described herein. As such, the computing device 1700 of FIG. 17 implements at least a portion of the method(s) described herein.

Some or all components of the computing device 1700 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 17, the computing device 1700 includes a user interface 1702, a Central Processing Unit (CPU) 1706, a system bus 1710, a memory 1712 connected to and accessible by other portions of computing device 1700 through system bus 1710, a system interface 1760, and hardware entities 1714 connected to system bus 1710. The user interface can include input devices and output devices, which facilitate user-software interactions for controlling operations of the computing device 1700. The input devices include, but are not limited, a physical and/or touch keyboard 1750. The input devices can be connected to the computing device 1700 via a wired or wireless connection (e.g., a Bluetooth® connection). The output devices include, but are not limited to, a speaker 1752, a display 1754, and/or light emitting diodes 1756. System interface 1760 is configured to facilitate wired or wireless communications to and from external devices (e.g., network nodes such as access points, etc.).

At least some of the hardware entities 1714 perform actions involving access to and use of memory 1712, which can be a Radom Access Memory (RAM), a solid-state or disk driver and/or a Compact Disc Read Only Memory (CD-ROM). Hardware entities 1714 can include a disk drive unit 1716 including a computer-readable storage medium 1718 on which is stored one or more sets of instructions 1720 (e.g., software code) configured to implement one or more of the methodologies, procedures, or functions described herein. The instructions 1720 can also reside, completely or at least partially, within the memory 1712 and/or within the CPU 1706 during execution thereof by the computing device 1700. The memory 1712 and the CPU 1706 also can constitute machine-readable media. The term “machine-readable media”, as used here, refers to a single medium or multiple media (e.g., a centralized or distributed database, and/or associated caches and servers) that store the one or more sets of instructions 1720. The term “machine-readable media”, as used here, also refers to any medium that is capable of storing, encoding or carrying a set of instructions 1720 for execution by the computing device 1700 and that cause the computing device 1700 to perform any one or more of the methodologies of the present disclosure.

Computing device 1700 implements chain-based technology. In this regard, computing device 1700 runs one or more software applications 1722 for facilitating the creation of tokens (e.g., tokens 118, 124, 134 of FIG. 1), creation of chains (e.g., chain 300 of FIG. 3), the storage of chains as a digital ledger (e.g., digital ledger 114 of FIG. 1, chain 300 of FIG. 3) as ledger information 1724 in a datastore (e.g., datastore 108 of FIG. 1), and/or controlled access to resources in accordance with a chain based technique as described herein. Other operations and/or functions of software applications 1722 are evident from other portions of this document. The present solution is not limited to the particulars of this example.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above-described embodiments. Rather, the scope of the present solution should be defined in accordance with the following claims and their equivalents.

What is claimed is:

1. A method for non-custodial peer-to-peer lending, comprising:
providing, by a computing device, an online loan service;
receiving, by the computing device, a request from a user for a collateral loan to be facilitated by the online loan service;
modifying, by the computing device, a digital ledger to include a block comprising details of the loan request;
receiving, by the computing device, at least one offer for the loan request;
modifying, by the computing device, the digital ledger to include a block comprising details of the at least one offer;
performing operations, by the computing device, to start the collateral loan;
obtaining, by the computing device, a collateral token associated with collateral to be used to secure the collateral loan;
modifying, by the computing device, the digital ledger to include a block comprising the collateral token and a smart contract specifying parties and terms of the collateral loan;
providing, by the computing device, a debt token to a borrower of the collateral loan, the debt token configured to allow loan debt to be sold; and
allocating and providing, to each lender of the collateral loan, lender tokens that collectively represent a percentage of the collateral loan that the lender is owed and which are configured to allow loan shares to be sold.

2. The method of claim 1, wherein:
the digital ledger comprises a cryptographically secure chain of blocks; and
modifying the digital ledger to include a block comprises adding the block to the chain of blocks, the added block comprising a cryptographic hash of a previous block in the chain.

3. The method of claim 1, further comprising, before modifying the digital ledger to include a block comprising the details of the loan request, obtaining, by the computing device, cryptographically signed details of the loan request.

4. The method of claim 1, wherein modifying the digital ledger to include a block comprising the details of the loan request comprises modifying the digital ledger to include a borrower identifier, a loan amount, a currency type, an interest rate, and a loan duration.

5. The method of claim 1, wherein modifying the digital ledger to include a block comprising the details of the loan request comprises modifying the digital ledger to include collateral value evidence.

6. The method of claim 1, wherein the smart contract specifies terms of the collateral loan comprising: debt payment terms, debt-token sale/purchase terms, lender-token sale/purchase terms, debt-token/collateral exchange terms, or lender-token/currency exchange terms.

7. The method of claim 1, wherein the collateral token is a non-fungible token associated with a digital file.

8. The method of claim 1, further comprising, prior to modifying the digital ledger to include the block comprising details of the at least one offer, receiving, by the computing device, a selection of the at least one offer by the user.

9. The method of claim 8, further comprising, prior to performing the operations to start the collateral loan, checking, by the computing device, that the selected offers meet at least one criterion of the loan request.

10. The method of claim 9, wherein checking that the selected offers meet the at least one criterion of the loan request comprises checking that a time period for offers has not expired.

11. The method of claim 1, wherein:
the details of the loan request comprise a loan amount and a collateral value; and
the method further comprises, prior to performing the operations to start the collateral loan, checking by the computing device, that the loan amount does not exceed the collateral value.

12. The method of claim 1, wherein allocating and providing lender tokens comprises:
receiving, by the computing device, a user selection of a plurality of offers from a plurality of lenders; and
providing, by the computing device, lender tokens to each of the plurality of lenders based on the offer associated with each lender.

13. The method of claim 1, further comprising:
receiving, by the computing device, one or more loan repayments; and
in response to the one or more loan repayments satisfying a repayment term of the collateral loan:
allowing exchange of the debt token for the collateral token; and
allowing exchange of lender tokens for currency.

14. The method of claim 1, further comprising:
receiving, by the computing device, debt-token purchase information; and
modifying, by the computing device, the digital ledger to include a block comprising the debt-token purchase information.

15. The method of claim 1, further comprising:
receiving, by the computing device, lender-token purchase information; and
modifying, by the computing device, the digital ledger to include a block comprising the lender-token purchase information.

16. The method of claim 1, wherein providing the online loan service comprises providing a user interface to receive the request from the user for the collateral loan to be facilitated by the online loan service.

17. The method of claim 1, wherein receiving the at least one offer for the loan request comprises receiving a trait-based offer.
